(19) United States
(12) Patent Application Publication
(10) Pub. No.: US 2003/0218786 A1
(43) Pub. Date: Nov. 27, 2003

(54) Method for generating a holographic visual effect and decoration plate formed by the method

(76) Inventors: Wen-Chin Yao, Taipei (TW); Jen-Hung Weng, Taoyuan (TW); Wei-Che Hsu, Taipei (TW)

Correspondence Address: Michael D. Bednarek, Shaw Pittman LLP, 1650 Tysons Boulevard, McLean, VA, 22102, US

(21) Appl. No.: 10/442,937

(22) Filed: May 22, 2003

(30) Foreign Application Priority Data
May 24, 2002 (TW) 91111098

(51) Int. Cl. G03H 1/00

(52) U.S. Cl. 359/2; 359/35

(57) ABSTRACT

The present invention provides a method for generating a holographic visual effect and a decoration plate formed by the method. The method includes forming an original plate having a first texture by using the holography; forming an mold plunger having a second texture corresponding to the first texture by using the original plate; forming a body having a third texture corresponding to the second texture by using the mold plunger; forming a cover layer by covering an outside of the third texture with a light reflective material. Observed the outside of the third texture, the cover layer and the third texture together generate the holographic visual effect.

This application claims priority of Taiwan Patent Application No. 091111098 filed on May 24, 2002.

### FIELD OF THE INVENTION

The present invention relates to a method for generating a holographic visual effect and a decoration plate made by this method.

### BACKGROUND OF THE INVENTION

Recently, the holography technology has gradually become mature. It is widely used to manufacture various kinds of products, such as decoration plate, nameplate, and compact disc.

The holography technology mentioned here may include recording light interferometric fringes on a sensitive film to form a holographic original plate. Traditionally, photoresist is used to record the light interferometric fringes and form the original plate.

Generally, two different interferometric fringes are used to form the original plate, real light interferometric fringes and computer-modeled interferometric fringes.

The first kind of fringes are illuminated on a substrate sprayed with emulsion so that the fringes are recorded on the substrate. Then the substrate is developed and fixed. Finally, the substrate is electroplated with metal material to form the original plate.

As to the second kind of fringes, a mask with a pattern is made based on the fringes first. Then the pattern is transferred to a substrate sprayed with photoresist by implementing exposure process. Finally, the substrate is etched to form the original plate.

After the original plate is formed, electroforming the original plate may form a mold. Conventionally, the mold is used to impress on a media to form the holographic products.

Moreover, the mold also may be electroformed to form the metal holographic products, such as metal decoration plate and nameplate. However, this method needs longer time for the electroforming process and costs more.

### SUMMARY OF THE INVENTION

It is an aspect of the present invention to provide a method for generating a holographic visual effect to save the costs and time of manufacturing.

It is another aspect of the present invention to provide a method for generating a holographic visual effect to manufacture a decoration plate, which has desired shape and structure.

The method of the present invention includes the following steps. (1) Forming an original plate, which has a first texture with a holography technique. (2) Using the original plate to form a mold plunger, which includes a second texture corresponding to the first texture. (3) Using the mold plunger to form a body, which has a third texture corresponding to the second texture. (4) Covering an outside of the third texture with a light reflective material to form a cover layer. Observed from the outside, the cover layer and the third texture together generate the holographic visual effect.

In another embodiment, the method of the present invention includes preparing an outer mold and forming the body between the mold plunger and the outer mold. According to different usage, different outer molds may be used to form the body, which has different specific shape or different specific functional structure.

The present invention also provides a decoration plate with a holographic visual effect. The decoration plate includes a body and a cover layer. The body has a holographic texture. The cover layer covers an outside of the holographic texture. Observed from the outside, the cover layer and the holographic texture together generate the holographic visual effect.

This and other aspects of the present invention will become clear to those of ordinary skill in the art after having read the following detailed description of the preferred embodiment which is illustrated in the various figures and drawings.

### BRIEF DESCRIPTION OF THE DRAWINGS

FIG. 1 shows a flow chart of an embodiment according to the present invention;

FIG. 2 shows a flow chart of another embodiment according to the present invention;

FIG. 3 shows a profile of the original plate and the mold plunger;

FIG. 4 shows a profile of the mold plunger and the body;

FIG. 5 shows an embodiment of the decoration plate according to the present invention.

### DETAILED DESCRIPTION

The present invention provides a method for generating a holographic visual effect and a decoration plate made by this method. This method may be used to form the decoration plate having a holographic visual effect; however, this method also may be used to form other products, such as nameplate and light-reflective label.

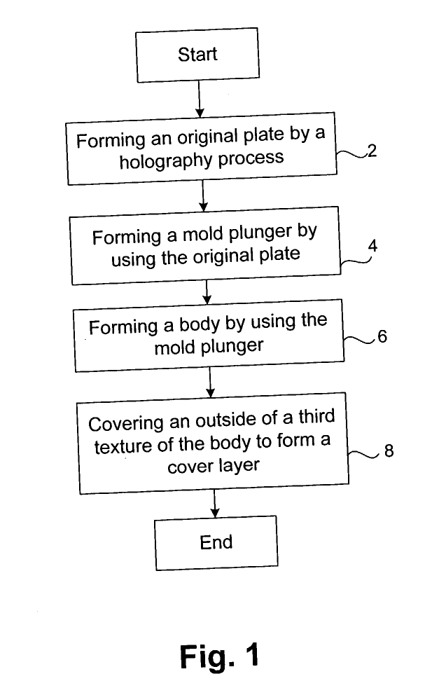

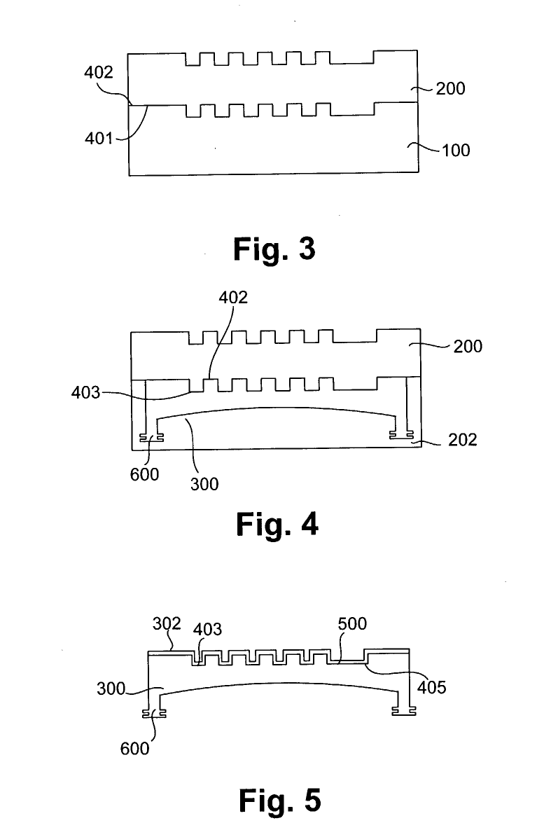

FIG. 1 and FIG. 3 are referred to hereinafter. FIG. 1 shows an exemplary flow chart of the present invention. In step 2, an original plate 100 having a first texture 401 is formed in a holography process. The holography process mentioned here may include using light interferometric fringes, computer-modeled interferometric fringes, or other similar technologies. In this embodiment, the first texture 401 is a record of a trace of interferometric fringes.

In step 4, a mold plunger 200 is formed by using the original plate 100. As FIG. 3 shows, the mold plunger 200 includes a second texture 402, which is corresponding to the first texture 401. In a preferred embodiment, the invention electroforms the original plate 100, on which then the mold plunger 200 is formed. However, in other embodiments, other methods, such as casting process, may be used to form the mold plunger 200.

In step 6, a body 300 is formed by using the mold plunger 200. As FIG. 4 shows, the body 300 has a third texture 403 corresponding to the second texture 402. As mentioned above, the second texture 402 also corresponds to the first texture 401; hence, the third texture 403 is identical to the first texture 401. In a preferred embodiment, the body 300 is formed by using injection-molding process. In other embodiments, the body 300 may be formed by other methods, such as casting process. In addition, the body 300 maybe made of plastic materials, glass, metal, or other materials. Moreover, some materials, such as nylon, fiber, and polymer, may be mixed into the material of body 300 to strengthen or to glorify the body 300.

In step 8, an outside 500 of the third texture 403 is covered with a light reflective material to form a cover layer 302, as FIG. 5 shows. The cover layer 302 has a substantially unique thickness and undulates along with the third texture 403. In a preferred embodiment, the outside 500 is electroplated to form the cover layer 302. In other embodiments, the body 300 may be formed by other methods, such as electroforming or spreading process. The light reflective material mentioned above may include nickel, aluminum, zinc, and other similar materials.

Observed from the outside 500, the cover layer 302 and the third texture 403 together generate the holographic visual effect. In a preferred embodiment, the holographic visual effect includes a light ripple with various kinds of colors. In other embodiments, the holographic visual effect may include other visual effects, such as a three-dimensional visual effect.

Differing from the traditional skill using electroforming process to form the entire decoration plate, the present invention adopts electroforming process to form the cover layer 302 only, which is thus thinner compared to traditional skill. Besides, the total producing time may be reduced because the electroforming process time is minimized.

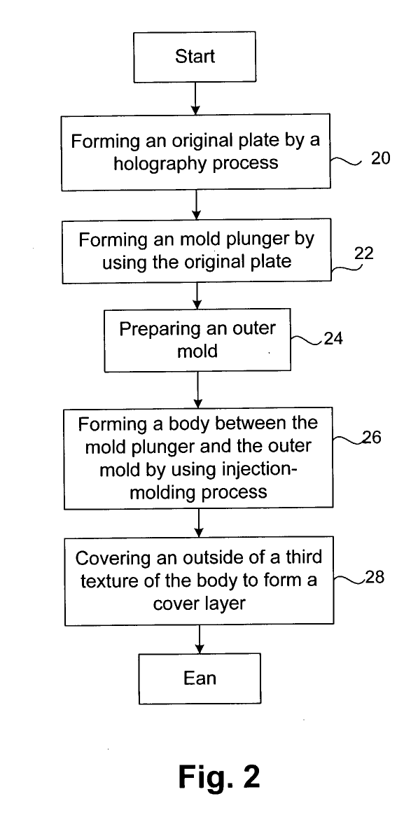

FIG. 2 shows a flow chart of another embodiment according to the present invention. The details of step 20 and step 22 in FIG. 2 are respectively identical to step 2 and step 4 in FIG. 1. Step 24 is preparing an outer mold as shown in FIG. 4. According to different usage, different outer mold 202 may be used to form the body 300, which has different specific shape or different specific functional structure 600, as FIG. 5 shows. The specific shape or the specific functional structure 600 may be used to connect the body 300 to other elements.

In step 26, the body 300 is formed between the mold plunger 300 and the outer mold 202. In a preferred embodiment, the body 300 is formed by using injection-molding process. In other embodiments, the body 300 may be formed by using other process, such as casting process.

The present invention also provides a decoration plate with a holographic visual effect. The decoration plate may be used to decorate any kind of product. It may also be used as nameplate showing characters or symbols.

As FIG. 5 shows, the decoration plate includes a body 300 and a cover layer 302. The body 300 has a holographic texture 405. The cover layer 302 covers an outside 500 of the holographic texture 405. Observed from the outside 500, the cover layer 302 and the holographic texture 405 together generate the holographic visual effect. In a preferred embodiment, the holographic visual effect includes a light ripple with various kinds of colors. In other embodiments, the holographic visual effect may include other visual effects, such as a three-dimensional visual effect.

In a preferred embodiment, the cover layer 302 is formed by a light reflective material. The light reflective material mentioned above may include nickel, aluminum, zinc, and other similar materials.

The body 300 includes a functional structure 600, as FIG. 5 shows. The functional structure 600 has a specific function; for example, the functional structure 600 can connect the body 300 to other elements.

Those skilled in the art will readily observe that numerous modifications and alterations of the device may be made within the teaching of the invention. Accordingly, the above disclosure should be construed as limited only by the metes and bounds of the appended claims.

1. A method for generating a holographic visual effect, said method comprising:
forming an original plate having a first texture by a holography process;
forming a mold plunger, having a second texture corresponding to said first texture, by using said original plate;
forming a body, having a third texture corresponding to said second texture, by using said mold plunger;
covering an outside of said third texture with a light reflective material to form a cover layer;
wherein said cover layer and said third texture together generate said holographic visual effect when observing from said outside of said third texture.

2. The method of claim 1, wherein said mold plunger is formed by electroforming said original plate.

3. The method of claim 1, wherein said body is formed between said mold plunger and an outer mold.

4. The method of claim 3, wherein said body is formed by using injection-molding process.

5. The method of claim 1, wherein said cover layer is formed by electroplateing said outside of said third texture with said material.

6. A method for generating a holographic visual effect, said method comprising:
forming an original plate having a first texture by a holography process;
forming a mold plunger, having a second texture corresponding to said first texture, by using said original plate;
preparing an outer mold;
forming a body between said mold plunger and said outer mold by using injection-molding process, said body having a third texture corresponding to said second texture;
covering an outside of said third texture with a light reflective material to form a cover layer;
wherein said cover layer and said third texture together generate said holographic visual effect when observing from said outside of said third texture.

7. The method of claim 6, wherein said mold plunger is formed by electroforming said original plate.

8. The method of claim 6, wherein said cover layer is formed by electroplateing said outside of said third texture with said material.

9. A method for producing a decoration plate with a holographic visual effect, said method comprising:
forming an original plate having a first texture by a holography process;
forming a mold plunger, having a second texture corresponding to said first texture, by using said original plate;
preparing an outer mold;
forming a body between said mold plunger and said outer mold by using injection-molding process, said body having a third texture corresponding to said second texture;
covering an outside of said third texture with a light reflective material to form a cover layer;
wherein said cover layer and said third texture together generate said holographic visual effect when observed from said outside of said third texture.

10. The method of claim 9, wherein said mold plunger is formed by electroforming said original plate.

11. The method of claim 9, wherein said cover layer is formed by electroplateing said outside of said third texture with said material.

12. A decoration plate with a holographic visual effect, comprising:
a body having a holographic texture; and
a cover layer covering an outside of said holographic texture;
wherein said cover layer and said holographic texture together generate said holographic visual effect when observing from said outside of said holographic texture.

13. The decoration plate of claim 12, wherein said cover layer is formed by a light reflective material.

14. The decoration plate of claim 12, wherein said body includes a functional structure.
